(19) United States
(12) Patent Application Publication
(10) Pub. No.: US 2010/0046398 A1
(43) Pub. Date: Feb. 25, 2010

(54) METHOD AND SYSTEM FOR AUTOMATICALLY REALIZING CONNECTION BETWEEN MANAGEMENT DEVICE AND MANAGED DEVICE

(75) Inventors: Li YANG, Shenzhen (CN); Weiguo NIU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/608,502

(22) Filed: Oct. 29, 2009

Related U.S. Application Data
(63) Continuation of application No. PCT/CN2008/070836, filed on Apr. 28, 2008.

(30) Foreign Application Priority Data
Apr. 29, 2007 (CN) 200710097757.7

(51) Int. Cl. H04L 12/28

(52) U.S. Cl. 370/254

(57) ABSTRACT

A method for automatically realizing a connection between a management device and a managed device is provided, which includes the following steps. The managed device acquires connection configuration parameters. The managed device establishes the connection according to the connection configuration parameters with the management device. A system for automatically realizing a connection between a management device and a managed device is also provided.

### CROSS-REFERENCE TO RELATED APPLICATIONS

This application is a continuation of International Patent Application No. PCT/CN2008/070836, filed Apr. 28, 2008, which claims priority to Chinese Patent Application No. 200710097757.7, filed Apr. 29, 2007, both of which are hereby incorporated by reference in their entireties.

### FIELD OF THE TECHNOLOGY

The present invention relates to the field of network device management technology, and more particularly to a method and a system for automatically realizing a connection between a management device and a managed device.

### BACKGROUND OF THE INVENTION

In a management structure of a mobile communication network, there are different network elements (NEs) located in the lower layer, and the NE is a managed device which is managed by an Element Management System (EMS) located in the middle layer. A Network Management System (NMS) located in the upper layer is a device for managing the NE and the EMS. In such a management structure, it is required to establish a connection between the NE and the EMS, so that the EMS can manage the NE. Generally, one NE has a unique EMS corresponding to the NE.

To establish a connection between the NE and the EMS, the NE or the EMS should know the information of each other, such as a connection address and a connection type. In a current mobile network, the connection between the NE and the EMS may be a connection based on Asynchronous Transfer Mode (ATM) or an IP connection based on Ethernet. If the connection is an IP connection based on Ethernet, information about the NE and the EMS, like IP addresses, connection types such as Transmission Control Protocol (TCP)/User Datagram Protocol (UDP), ports, etc., is necessary for establishing the connection. If the connection is a connection based on ATM, information such as a Virtual Path Identifier (VPI)/a Virtual Channel Identifier (VCI) assigned for the connection between the NE and the EMS is necessary for establishing the connection.

The connection between the NE and the EMS is an initial step to establish a management network. When the connection is established between the NE and the EMS, network management information can be transmitted between the NE and the EMS through the connection, and the operation conditions of the NE device, such as Operation and Maintenance (OM) link creation, software loading and activation, signaling link management, service link management, and wireless resource management, can be fed back.

In the prior art, the established IP connection based on Ethernet between the NE and the EMS is planned and configured manually. The NE and the corresponding EMS are manually planned. At the EMS side, the IP address and port of the EMS are determined, and the IP address, port, and connection type of the NE which has established a connection therewith are configured; then at the NE side, the IP address and port of the NE and the IP address, port, and connection type of the EMS which has established a connection with the NE are configured. The connection between the NE and the EMS can be established after completing the configuration of these parameters.

In this solution, the connection parameters of the transmission layer, such as the IP address of the NE, the IP address of the corresponding EMS, the connection type, and the listening port, are completely configured through manual negotiation. In terms of efficiency, the NE and the EMS are configured at two sides respectively, and thus errors easily occur. Furthermore, the NE and the EMS are less efficient because they are kept consistent manually. In terms of cost, manual configuration of a great deal of NEs results in a high cost. In addition, in the current wireless network, more and more NEs are employed, and operators earnestly hope to realize the auto-configuration of the NEs, which cannot be achieved by manual configuration.

To establish the connection based on ATM between the NE and the corresponding EMS, the information such as VPI/VCI assigned for the connection at the NE side and the EMS side is necessary and the identifiers (IDs) of the VPI/VCI are also negotiated and planned manually. After acquiring the information assigned for the connection, the NE and the EMS configure the ATM link, and complete the establishment of the connection between the NE and the EMS. In such a case, the bandwidth assigned for the OM link is constant.

In this solution, the NE and the EMS should negotiate and assign VPI/VCI in advance, and then process to configure for the connection. As a result, the efficiency is low, and the cost of the manual operation is high. In addition, since the bandwidth assigned for the OM is constant in this solution, the requirements of the system for the different bandwidths of the OM link in different phases cannot be satisfied. If the configured bandwidth is not wide enough, transmission of a lot of data may suffer congestion or is very time-consuming. If the configured bandwidth is wide, the bandwidth is wasted when only a little data is transmitted.

Therefore, in the prior art, neither the connection based on ATM nor the IP connection based on Ethernet can realize auto-configuration, and as a result, the connection between the management device and the managed device is established in a low efficiency and with high cost.

### SUMMARY OF THE INVENTION

A method and a system for automatically realizing a connection between a management device and a managed device are provided in the embodiments of the present invention, and automatically configuring and creating the connection between the management device and the managed device becomes possible.

An embodiment of the present invention provides a method for automatically realizing a connection between a management device and a managed device, which includes the following steps.

The management device and the managed device acquire connection configuration parameters.

The management device and the managed device establish a connection according to the connection configuration parameters.

Another embodiment of the present invention further provides a system for automatically realizing a connection between a management device and a managed device, which includes a management device, a managed device, and an address service device. Further, the address service device is adapted to provide connection configuration parameters of the managed device and the management device for the managed device, so as to establish a connection between the management device and the managed device.

Another embodiment of the present invention further provides an address service device adapted to provide connection configuration parameters of the managed device and the management device for the managed device, so as to establish a connection between the management device and the managed device.

Another embodiment of the present invention further provides a system for automatically realizing a connection between a management device and a managed device. The management device and the managed device are pre-configured with a constant VPI/VCI, and establish an initial link through the VPI/VCI. Further, the managed device reports the available VPI/VCI at this side to the management device through the initial link. The management device checks the VPI/VCI which can be assigned for the managed device, and negotiates with the managed device to acquire the negotiation bandwidth, thereby determining the VPI/VCI which needs to be assigned for the link.

In the embodiments of the present invention, if it is required to create a new network, or to add a new NE to the existing network, or to move an NE, or to re-adjust the layout and the connection of NEs, the connection between the management device and the managed device can be automatically configured. In this way, both the difficulty and cost to configure the connection between the management device and the managed device are reduced.

In the embodiments of the present invention, the assignment of the bandwidth of the ATM link between the NE and EMS is optimized. Through negotiation between the NE and EMS, different bandwidths are configured for the OM according to different requirements of the OM for the link bandwidth in different phases. Therefore, it can be avoided that too small bandwidth for downloading software and configuring a great deal of data in the installation and configuration phase is configured, thus the installation and configuration is speeded up. In addition, it can also be avoided that too wide bandwidth for the OM link is reserved for the normal operation of the system, and thus the wasted bandwidth is reduced.

### BRIEF DESCRIPTION OF THE DRAWINGS

FIG. 1 is a flow chart of a method for automatically realizing a connection between a management device and a managed device according to an embodiment of the present invention;

FIG. 2 is a flow chart of automatically configuring a connection between the NE and the EMS, when the IP connection is based on Ethernet, according to an embodiment of the present invention;

FIG. 3 is a flow chart of automatically configuring a connection between the NE and the EMS, where a DHCP server serves directly as an address service device, according to an embodiment of the present invention;

FIG. 4 is a flow chart of automatically configuring a connection between the NE and the EMS, where a DHCP server plus a naming server provide the function of an address service device, according to an embodiment of the present invention;

FIG. 6 is a flow chart of automatically configuring a connection between the NE and the EMS, when the IP connection is based on ATM, according to an embodiment of the present invention;

FIG. 7 is a structural diagram of a system for automatically realizing a connection between a management device and a managed device according to an embodiment of the present invention;

FIG. 8 is a structural diagram of a system for automatically realizing a connection between a management device and a managed device according to another embodiment of the present invention; and

FIG. 9 is a structural diagram of another system for automatically realizing a connection between a management device and a managed device according to still another embodiment of the present invention.

### DETAILED DESCRIPTION OF THE EMBODIMENTS

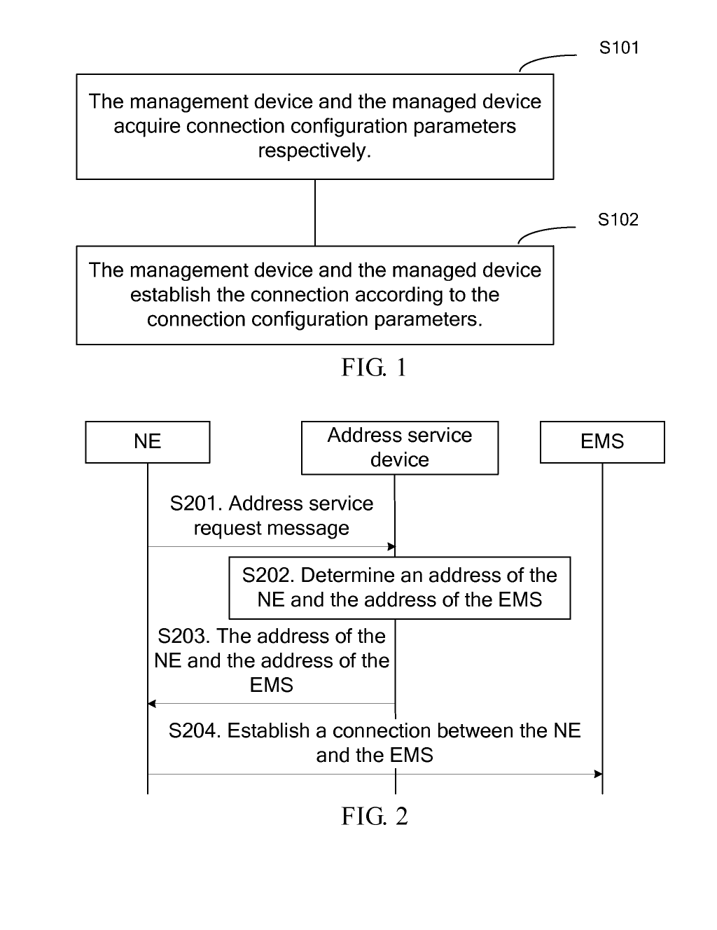

The embodiments of the present invention provide a method for automatically realizing a connection between a management device and a managed device, which, as shown in FIG. 1, includes the following steps.

In step S101, the management device and the managed device acquire connection configuration parameters respectively.

When the connection is an IP connection based on Ethernet, the connection configuration parameters include communication addresses and connection types of the management device and the managed device. The communication address includes a network address and a connection port number. The embodiments of the present invention take the IP addresses as examples of the addresses of the management device and the managed device. However, the communication addresses are not limited to IP addresses. The process of acquiring the connection configuration parameters specifically includes: setting an address service device to assign the IP address for the managed device and inquire the IP address of the management device which the managed device is subordinated to according to the ID of the managed device; and acquiring, by the managed device, the IP address of the managed device and the IP address of the management device from the address service device. Alternatively, the managed device acquires the connection type and the connection port number from the address service device, or the management device and the managed device pre-set the connection type and the connection port.

When the connection is an IP connection based on ATM, the connection configuration parameter is a virtual path identifier (VPI)/virtual channel path (VCI). The process of acquiring the connection configuration parameter specifically includes the following steps. The management device and the managed device establish an initial OM link by using the pre-configured VPI/VCI. The management device acquires the VPI/VCI available for the managed device via the initial OM link. At the management device side, the management device inquires the VPI/VCI which can be assigned for the managed device to establish the connection. The management device and the managed device negotiate the bandwidth, and assign the corresponding VPI/VCI for the OM link according to a result of the negotiation.

In step S102, the management device and the managed device establish a connection according to the connection configuration parameters. To establish an IP connection which is between the NE and the EMS, the NE may directly initiate the process of connection establishment corresponding to learning about the information such as the address and connection type of the EMS. In such a process, the NE reports information of itself, such as address information, to a destination address which may be the address of the EMS for example. Alternatively, a process of link negotiation may be included in the process of the connection establishment between the management device and the managed device according to the connection configuration parameters, or be initiated according to the requirement in the process of the system operation. Alternatively, the process of the link negotiation may be initiated by the management device or the managed device. If the process of the link negotiation is initiated by the management device, the specific process includes the following steps. The management device sends a bandwidth negotiation request to the managed device which reports a desired bandwidth and an available bandwidth at the management device side. According to the current situation, the managed device inquires the bandwidth at the managed device side which can be provided for the management device. Then, according to the bandwidth at the management device side and the bandwidth at the managed device side, the managed device determines the bandwidth used for the link between the management device and the managed device, and notifies the management device through a response message. If the process of the link negotiation is initiated by the managed device, the specific process includes the following steps. The managed device sends a bandwidth negotiation request to the management device which reports a desired bandwidth and an available bandwidth resource at the managed device side. According to the current situations, the management device inquires the bandwidth at the management device side which can be provided for the link between the managed device and the management device. Then, according to the bandwidth at the management device side and the bandwidth at the managed device side, the management device determines the bandwidth used for the link between the management device and the managed device, and notifies the managed device through a response message.

In the embodiments of the present invention, the management device may be an EMS, and the managed device may be an NE. Alternatively, the management device may be an NMS, and the managed device may be an EMS. In the following embodiments, an EMS and an NE are respectively taken as the management device and the managed device. If the management device is an NMS and the managed device is an EMS, the process is the similar, and will not be repeated.

When the connection is an IP connection based on Ethernet, which means the IP connection is over Ethernet, an environment of full IP connection is provided and several parameters are necessary for the NE, such as IP address of the NE, the IP address of the EMS, the connection type between the NE and EMS, and the connection port number between the NE and EMS. To automatically configure and establish the connection between the NE and the EMS, an address service device is adopted in the embodiments of the present invention. The address service device may automatically assign an address for the NE according to the ID information of the NE, and search the address of the corresponding EMS according to the ID information of the NE. Other parameters may be set through an appointment, or set in the address server.

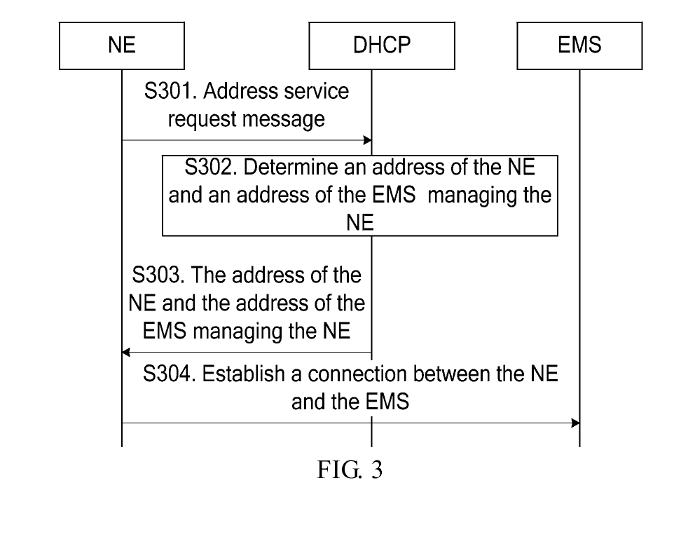

As shown in FIG. 2, the process of automatically configuring a connection between the NE and the EMS includes the following steps.

In step S201, after being physically connected and powered on, the NE sends an address service request message to the address service device to acquire an IP address. The address service request message includes the ID of the NE and the manufacturer ID of the NE.

In step S202, the address service device, after receiving the address service request message from the NE, determines an IP address to be assigned for the NE according to the ID and the manufacturer ID of the NE, and searches the IP address of the EMS which the NE is subordinated to, the connection type, and the connection port number. To search the IP address, the connection type, and the connection port number, the address service device should be preset.

In step S203, the address service device sends a response message to the NE, which includes the information such as the IP address of the NE, the IP address of the EMS managing the NE, and the connection type and the port number between the NE and the EMS.

In step S204, the NE, after receiving the information necessary for establishing the connection from the address service device, initiates the process to establish the connection with the EMS, and the connection between the NE and the EMS is established.

In the aforementioned steps, there are various manners to constitute the address service device. For example, in the following descriptions, the address service device may be a Dynamic Host Configure Protocol (DHCP) server, or be constituted by a DHCP server and a naming server.

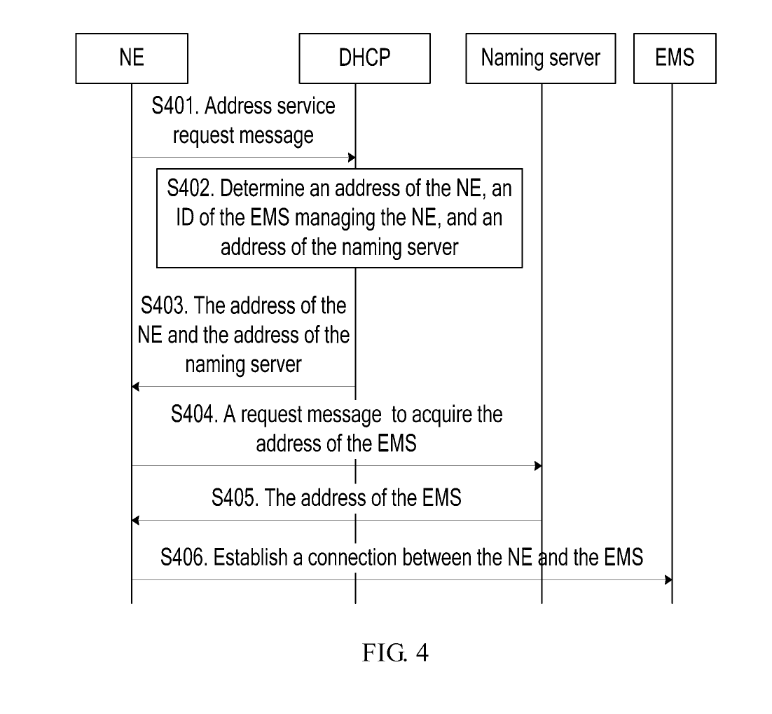

In an example, the function of the address service device is completed by the DHCP server directly. The extended option of the DHCP server is set in advance, so as to search the address of the EMS and set the information such as the connection type and the port number of the EMS. As shown in FIG. 3, the process of automatically configuring the connection between the NE and the EMS includes the following steps.

In step S301, the NE sends an address service request message to the DHCP server to acquire an IP address. The address service request message includes the ID of the NE and the manufacturer ID of the NE.

In step S302, the DHCP server, after receiving the address service request message from the NE, determines an IP address to be assigned for the NE and an IP address of the EMS managing the NE according to the ID of the NE and the manufacturer ID of the NE. The extended option of the DHCP server should be set in advance, so as to search the IP address of the EMS, the connection type, and the port number of the EMS.

In step S303, the DHCP server sends the response message to the NE, which includes the information such as the IP address of the NE, the IP address of the EMS managing the NE, the connection type, and the port number of the EMS.

In step S304, the NE, after receiving the information necessary for establishing the connection from the address server, initiates the process to establish the connection with the EMS, and the connection between the NE and the EMS is established.

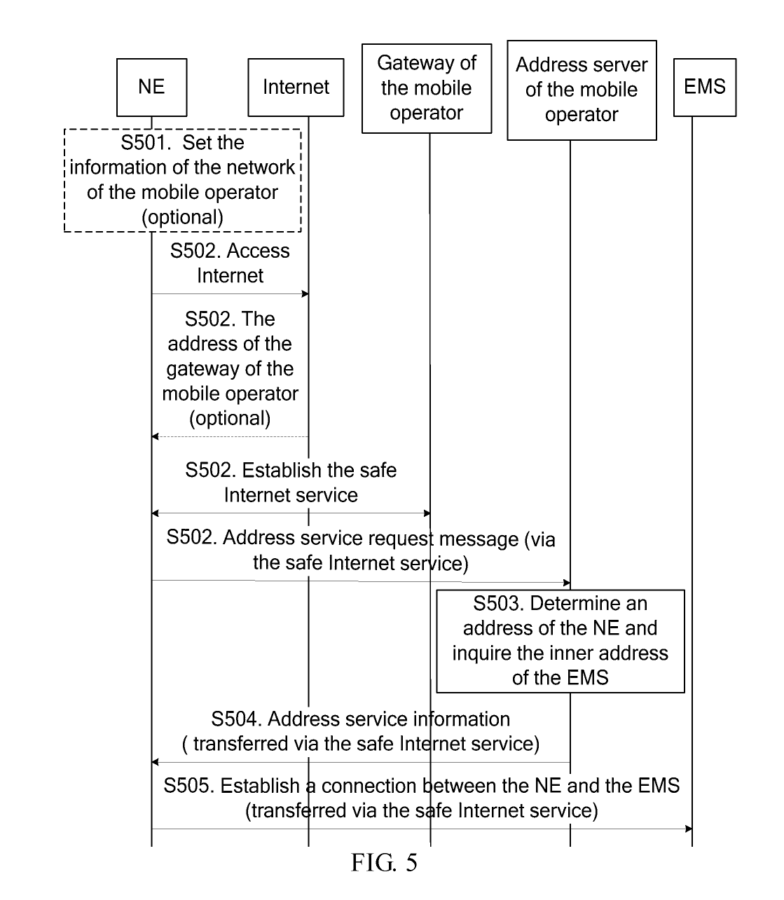

In another example, the function of the address service device is completed by the DHCP server and the naming server. The extended option of the DHCP server is set in advance, so as to search the ID of the EMS and the address of the naming server, and set the information such as the connection type and the port number of the EMS. As shown in FIG. 4, the process of automatically configuring the connection between the NE and the EMS includes the following steps.

In step S401, the NE sends an address service request message to the DHCP server to acquire an IP address. The address service request message includes the ID of the NE and the manufacturer ID of the NE.

In step S402, the DHCP server, after receiving the address service request message from the NE, determines an IP address to be assigned for the NE, an ID of the EMS managing the NE, and an address of the naming server according to the ID of the NE and the manufacturer ID of the NE. The extended option of the DHCP server should be set in advance, so as to search the information such as the ID of the EMS, the address of the naming address, and the port number of the EMS.

In step S403, the DHCP server sends a response message to the NE, which includes the information such as the IP address of the NE, the ID of the EMS managing the NE, the address of the naming server, the connection type, and the port number of the EMS.

In step S404, the NE sends a request message to the naming server to acquire the IP address of the EMS. The request message includes the ID of the EMS.

In step S405, the naming server sends the IP address of the EMS to the NE according to the ID of the EMS.

In step S406, the NE receives the information necessary for establishing the connection from the DHCP server and the naming server, and initiates the process to establish the connection with the EMS, and the connection between the NE and the EMS is established.

The address service device in the embodiments of the present invention may be, but not limited to, the DHCP server or the DHCP server plus the naming server. Any protocol or protocol combination can serve as the protocol for the address server if it can automatically assign the address for the NE and automatically search the IP address of the EMS which the NE is subordinated to. In addition, the information such as the connection type and the port number may be set in the DHCP server, or appointed in advance by the NE and the EMS.

In another embodiment of the present invention, the NE can access the network of an operator through the Internet. In such a situation, the information of the network of the mobile operator, such as the gateway address of the mobile operator, should be provided to the NE side, so that the NE can access the network of the mobile operator through the Internet and the gateway of the mobile operator. The NE accesses the Internet, and acquires the Internet service. Then the NE accesses the network of the mobile operator through the Internet service in a safe manner, and sends an address service request to the network of the mobile operator. When the address service request is received by the network of the mobile operator, the address server in the network of the mobile operator provides corresponding address service information, and then the connection between the NE and the corresponding EMS in the network of the mobile operator can be established according to the address service information.

The specific process of automatically configuring the connection between the NE and the EMS includes the following steps, as shown in FIG. 5.

In step S501, which is an optional step, the information of the network of the mobile operator, which the NE will access, is set at the NE side, or the network of the mobile operator, which the NE will access, is bound in Internet according to the ID information of the NE.

In step S502, the NE accesses the Internet, and optionally receives the address of the gateway of the mobile operator. Then, the NE acquires the Internet service, and sends address service request message via the Internet to the network of the mobile operator in a safe manner (for example, establish VPN, i.e., Virtual Private Network). The request message includes the ID of the NE and the manufacturer ID of the NE.

In step S503, when the address service request is received by the network of the mobile operator, the address server within the network of the mobile operator assigns an inner address for the NE, and inquires information such as the IP address of the EMS corresponding to the NE. Herein, the address server is set to complete the corresponding function, and the address server may be the DHCP server, or the DHCP server plus the naming server, or an Http Index Service.

In step S504, the address server within the network of the mobile operator sends the corresponding address service information to the NE through the safe Internet service. The address service information includes the address of the NE in the network of the mobile operator and the address of the EMS which the NE is subordinated to in the network of the mobile operator.

In step S505, the connection is established between the NE and the corresponding EMS in the network of the mobile operator according to the relevant address service information.

In this process, the NE accesses the gateway of the mobile operator in a safe network service manner, for example, VPN. The NE, and the address server and the EMS within the network of the mobile operator access the Internet through respective gateways, so as to interact and communicate using the Internet safety service. In all the aforementioned processes, the information such as the connection type and the port number may be alternatively set in the address server, or appointed by the two parties.

When the connection is an IP connection is based on ATM, which means the IP connection is over ATM, it is presented to the outside of the network that the network node provides IP service, but the bearer on its lower layer is transmitted based on an ATM link. Thus, a mechanism to convert an IP address and an ATM address to each other, for example, an IP Over ATM (IPOA) protocol, is required. To automatically configure and establish the connection between the NE and the EMS, the information such as VPI/VCI for establishing the connection needs to be automatically configured.

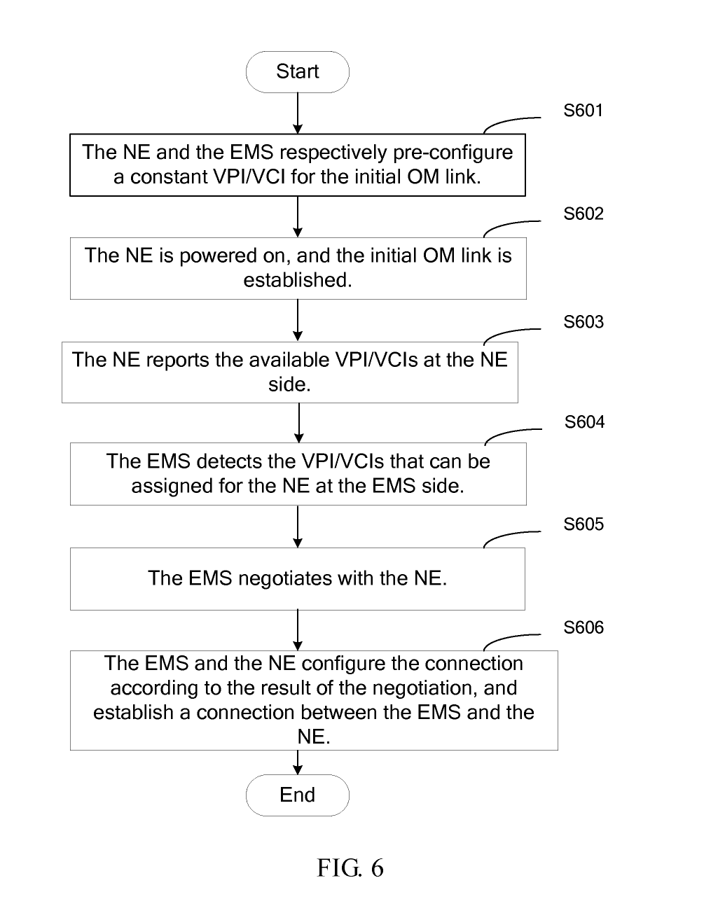

The solution under such a situation is specifically described as follows. Firstly, a constant VPI/VCI is respectively pre-configured at the NE side and the EMS side, which is assigned for the initial OM link. In the ATM connection, a part of the ports of the link between the NE and the EMS are assigned to transmit the OM information of the gateway, called an OM link, and the other part of the ports transmit service information. After the NE is powered on, the initial OM link is established according to the information such as pre-configured VPI/VCI. Then, the NE and the EMS negotiate for the bandwidth of the link, and configure the link according to the different requirements of a system on the bandwidth in different phases. The process of automatically configuring the connection between the NE and the EMS includes the following steps, as shown in FIG. 6.

In step S601, the NE and the EMS respectively pre-configure a constant VPI/VCI, and assign it for an initial OM link, where the initial VPI/VCI pre-configured by the EMS and the NE is known or appointed in advance.

In step S602, after the NE is powered on, the initial OM link is established according to the pre-configured VPI/VCI.

In step S603, the NE reports all the available VPI/VCI at the NE side to EMS via the initial OM link.

In step S604, after receiving the report from the NE, the EMS detects a VPI/VCI that can be assigned for the NE at the EMS side.

In step S605, the EMS negotiates with the NE, so as to determine which VPI/VCI are assigned for the OM link according to the different phases of the NE. The statuses of the NE include an installation and configuration phase and a normal operation phase. For example, in the installation and configuration phase, a wide bandwidth may be configured for the OM link. In addition, the process of negotiating the link may be initiated in any phase of the system according to the requirements, and after the necessary bandwidth operation, the bandwidth of the link may be resumed to the original level or negotiated again.

In step S606, the EMS and the NE configure the connection between the EMS and the NE according to the result of the negotiation. The connection between the EMS and the NE is established.

In the aforementioned step S605, there are two specific negotiation manners. In one manner, the NE sends a bandwidth negotiation request message to the EMS according to its phase or the current necessary operation, and reports the current desired bandwidth. After receiving the bandwidth negotiation request from the NE, the EMS sends a response to the NE according to the operation and service currently performed at the node of the EMS, and the situation of the current source of this node. The response message includes the result of the bandwidth negotiation. In the other manner, it is the EMS that initiates the negotiation with the NE on its own initiative, and the process is as follows. The EMS sends a bandwidth negotiation request message to the NE according to its phase or the current necessary operation, and reports the current desired bandwidth. After receiving the bandwidth negotiation request from the EMS, the NE sends a response to the EMS according to the operation and service currently performed at the node of the NE, and the situation of the current source of this node. The response message includes the result of the bandwidth negotiation.

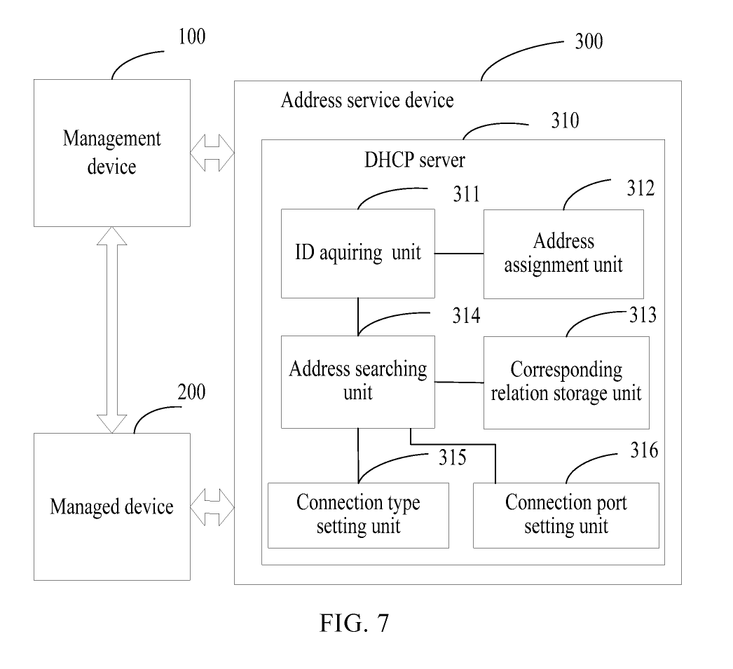

In an embodiment of the present invention, a system of automatically realizing a connection between a management device and a managed device is provided, as shown in FIG. 7, includes a management device 100, a managed device 200, and an address service device 300. The address service device 300 is adapted to provide the connection configuration parameters of the managed device 200 and the management device 100 for the managed device 200 to establish the connection between the management device 100 and the managed device 200.

Alternatively, the address service device 300 may be an independent DHCP server 310, which specifically includes: an ID acquiring unit 311 adapted to acquire an ID of the managed device, an address assignment unit 312 adapted to assign an address for the managed device according to the ID of the managed device, a corresponding relation storage unit 313 adapted to store a corresponding relation between the ID of the managed device and the address of the management device, an address searching unit 314 adapted to search the address of the management device in the corresponding relation storage unit 313 according to the ID of the managed device, and send the address to the managed device 200, a connection type setting unit 315 adapted to set the connection type between the managed device 200 and the management device 100, and/or a connection port setting unit 316 adapted to set a connection port between the managed device 200 and the management device 100.

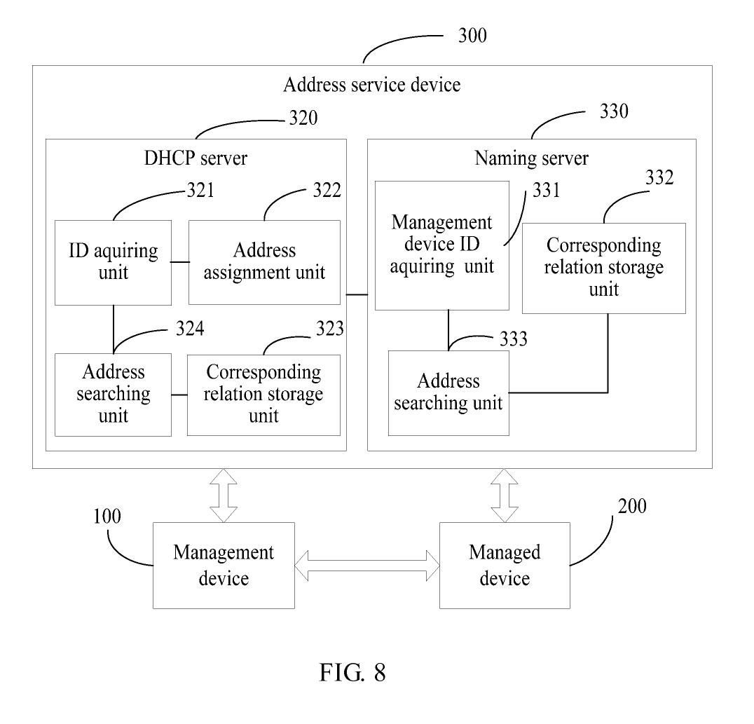

Alternatively, the address service device 300 may be a combination of the DHCP server 320 and the naming server 330, as shown in FIG. 8. The DHCP server 320 is adapted to assign an IP address for the managed device, and provide the ID of the management device for the managed device. The naming server 330 is adapted to provide the IP address of the management device for the managed device according to the ID.

Further, the DHCP server 320 specifically includes: an ID acquiring unit 321 adapted to acquire the ID of the managed device, an address assignment unit 322 adapted to assign an address for the managed device according to the ID of the managed device, a corresponding relation storage unit 323 adapted to store the corresponding relation between the managed device and the management device, and an address searching unit 324 adapted to search the ID of the management device in the corresponding relation storage unit 323 according to the ID of the managed device 200, and send the ID to the managed device 200. The naming server 330 specifically includes: a management device ID acquiring unit 331 adapted to acquire the ID of the management device from the managed device 200, a corresponding relation storage unit 332 adapted to store the corresponding relation between the ID of the management device and the address of the management device, and an address searching unit 333 adapted to search the address of the management device in the corresponding relation storage unit 332 according to the ID of the management device 100, and send the address to the managed device 200.

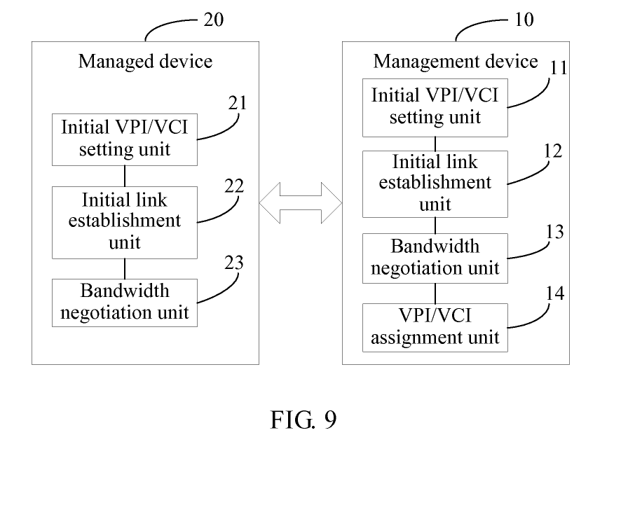

As shown in FIG. 9, another system of automatically realizing a connection between a management device and a managed device is provided in another embodiment of the present invention. The system includes a management device 10 and a managed device 20. The management device 10 and the managed device 20 pre-configure a constant VPI/VCI, and establish an initial link using the VPI/VCI. The managed device 20 reports available VPI/VCI at this side to the management device through the initial link, and the management device 10 detects a VPI/VCI which can be assigned for the managed device 20, and negotiates with the managed device 20 to acquire the negotiation bandwidth, thereby determining the VPI/VCI assigned for the link.

Further, the managed device 20 specifically includes: an initial VPI/VCI setting unit 21 adapted to set the initial VPI/VCI, an initial link establishment unit 22 adapted to establish the initial link with the management device according to the initial VPI/VCI, and a bandwidth negotiation unit 23 adapted to inquire a VPI/VCI which may be configured for the link with the management device at the managed device side, and determine the bandwidth of the link with the management device according to the situation of a VPI/VCI at the management device side and the managed device side.

Further, the management device 10 specifically includes: an initial VPI/VCI setting unit 11 adapted to set the initial VPI/VCI, an initial link establishment unit 12 adapted to establish the initial link with the managed device according to the initial VPI/VCI, a bandwidth negotiation unit 13 adapted to negotiate the employed bandwidth with the management device through the initial link, and a VPI/VCI assignment unit 14 adapted to inquire a VPI/VCI which may be configured for the link with the managed device at the management device side, and determine the bandwidth of the link with the managed device according to the situation of a VPI/VCI at the management device side and the managed device side. Alternatively, the bandwidth negotiation unit 13 may be adapted to inquire a VPI/VCI able to be configured for the link with the managed device at the management device side, and determine the bandwidth of the link with the managed device according to the situation of a VPI/VCI at the management device side and the managed device side; and the VPI/VCI assignment unit 14 may be adapted to assign the specific VPI/VCI according to the result of the negotiation.

The embodiments of the present invention are applicable for various situations, such as an operator intends to create a new network, or add a new NE to the existing network, or move an NE, or re-adjust the layout and the connection of NEs. In the embodiments of the present invention, the connection between the NE and the EMS (or between the EMS and the NMS) is automatically configured, thereby reducing the difficulty and cost of configuring the connection. As the network becomes more and more complicated, the network has more and more NEs. Thus, the operators have great desire to automatically realize configuring the NEs to reduce the manpower and material resources for the configuration. The embodiments of the present invention achieve the auto-configuration from the NE to the EMS by introduction of the address server and the method of automatically searching the address of the EMS.

The embodiments of the present invention further optimize the assignment of the ATM bandwidth of the connection between the NE and the EMS. The OM link between the NE and the EMS has different requirements on the bandwidth in different phases. For example, in the installation and configuration phase, a high bandwidth is needed, and when the system runs normally, a relatively constant bandwidth is needed. In the embodiments of the present invention, the NE and the EMS negotiate, and assign different bandwidths for the OM in different phases according to the different requirements of the system on the OM link in different phases. Therefore, it can be avoided that too small bandwidth for downloading software and configuring a great deal of data in the installation and configuration phase is configured, thus the installation and configuration is speeded up. In addition, it can also be avoided that too wide bandwidth for the OM link is reserved for the normal operation of the system, thus the wasted bandwidth is reduced.

According to the descriptions of the aforementioned embodiments, persons skilled in the art can clearly understand that, the present invention can be realized by hardware, or can be realized by means of software and necessary common hardware platforms. Based on such understanding, the technical solution of the present invention can be embodied in form of software, and the software product can be stored in a nonvolatile storage medium (such as CD-ROM, USB disk, and mobile hard disk), which includes several instructions to enable a computer (such as a personal computer, server, or a network device) to perform the methods in each embodiment of the present invention.

Only several specific embodiments of the present invention are disclosed. However, the present invention is not limited thereby. All the changes that can be thought of by those skilled in the art fall in the protection scope of the present invention.

What is claimed is:

1. A method for automatically realizing a connection between a management device and a managed device, comprising a process of automatically configuring the connection between the management device and the managed device, wherein the process further comprises:
acquiring, by the managed device, connection configuration parameters; and
establishing, by the managed device, a connection according to the connection configuration parameters with the management device.

2. The method of claim 1, wherein the establishing, by the managed device, the connection according to the connection configuration parameters, comprises a process of width negotiation, and the process of width negotiation further comprises:
initiating, by the management device, the process of bandwidth negotiation, and
sending a bandwidth negotiation request to the managed device to report a desired bandwidth and an available bandwidth at the management device side; and
inquiring, by the managed device, a link bandwidth available for the management device at the managed device side according to a current situation, and determining a link bandwidth between the management device and the managed device according to the bandwidth at the management device side and the bandwidth at the managed device side, and notifying the management device through a response message.

3. The method of claim 1, wherein the establishing, by the managed device, the connection according to the connection configuration parameters, comprises a process of width negotiation, and the process of width negotiation further comprises:
initiating, by the managed device, a process of bandwidth negotiation, and sending a bandwidth negotiation request to the management device to report a desired bandwidth and an available bandwidth resource at the managed device side; and
inquiring, by the management device, a link bandwidth at the management device side available for the connection between the managed device and the management device according to a current situation, and determining a link bandwidth between the management device and the managed device according to the bandwidth at the management device side and the bandwidth at the managed device side, and notifying the managed device through a response message.

4. The method of claim 1, wherein the connection is an IP connection based on Ethernet, and the connection configuration parameters comprise communication addresses of the management device and the managed device, and a connection type between the management device and the managed device.

5. The method of claim 4, wherein the acquiring, by the managed device, connection configuration parameters, comprises:
assigning, by an address service device, a communication address for the managed device, and inquiring a communication address of the management device according to an identifier (ID) of the managed device; and
acquiring, by the managed device, the communication address of the managed device and the communication address of the management device from the address service device.

6. The method of claim 5, further comprising:
acquiring, by the managed device, at least one of a connection type and a connection port number from the address service device; or
pre-setting, by the management device and the managed device, at least one of a connection type and a connection port.

7. The method of claim 5, wherein the address service device is a Dynamic Host Configure Protocol (DHCP) server; and
wherein the acquiring, by the managed device, the communication address of the managed device and the communication address of the management device from the address service device, further comprises:
sending, by the managed device, an address service request message including the ID of the managed device to the DHCP server;
determining, by the DHCP server, an IP address to be assigned for the managed device according to the ID of the managed device, and inquiring an IP address of the management device managing the managed device; and
sending, by the DHCP server, a response message including the IP address of the managed device and the IP address of the management device to the managed device.

8. The method of claim 5, wherein the address service device comprises a DHCP server and a naming server; and
wherein the acquiring, by the managed device, the communication address of the managed device and the communication address of the management device from the address service device, further comprises:
sending, by the managed device, an address service request message including ID of the managed device to the DHCP server;
determining, by the DHCP server, an IP address to be assigned for the managed device according to the ID of the managed device, and inquiring an ID of the management device managing the managed device and an address of the naming server;
sending, by the DHCP server, a response message including the IP address of the managed device, the ID of the management device and the address of the naming server to the managed device;
sending, by the managed device, a request message including the ID of the management device to the naming server; and
sending, by the naming server, an IP address of the management device to the managed device.

9. The method of claim 5, wherein the address service device is an address server in the network of a mobile operator; and
wherein the acquiring, by the managed device, the communication address of the managed device and the communication address of the management device from the address service device, further comprises:
sending, by the managed device, an address service request message including the ID of the managed device to the DHCP server in the network of the mobile operator;
determining, by the DHCP server in the network of the mobile operator, an address to be assigned for the managed device according to the ID of the managed device, and inquiring an address of the management device corresponding to the managed device; and
sending, by the DHCP server in the network of the mobile operator, a response message including the address of the managed device and the address of the management device to the managed device.

10. The method of claim 1, wherein the connection is an IP connection based on ATM, and the connection configuration parameters comprise one of a virtual path identifier (VPI) and a virtual channel path (VCI); and
the method further comprising acquiring, by the management device, the connection configuration parameters.

11. The method of claim 10, wherein the acquiring, by the managed device, the connection configuration parameters, comprises:
establishing, by the management device and the managed device, an initial Operation and Maintenance (OM) link, by using at least one of a pre-configured VPI and VCI;
acquiring, by the management device, at least one of an available VPI and VCI for the managed device via the initial OM link;
inquiring at the management device side, by the management device, at least one of a VPI and VCI available for the managed device to establish the link; and
negotiating a bandwidth, by the management device and the managed device, and assigning at least one of a VPI and VCI for the OM link according to a result of the negotiation.

12. The method of claim 11, wherein the process of width negotiation comprises:
sending, by the managed device, a bandwidth negotiation request to the management device to report a desired bandwidth and one of an available VPI and VCI at the managed device side; and
inquiring, by the management device, one of a VPI and VCI at the management device side available for the link between the managed device and the management device according to current situation, and determining a link bandwidth between the management device and the managed device according to one of the VPI and VCI at the management device side and the bandwidth at the managed device side, and notifying the managed device through a response message.

13. The method of claim 12, wherein the current situation comprises at least one of an installation and configuration phase, and a normal operation phase.

14. The method of claim 11, wherein the process of bandwidth negotiation comprises:
sending, by the management device, a bandwidth negotiation request to the managed device to report a desired bandwidth and one of an available VPI and VCI at the management device side;
inquiring, by the managed device, a bandwidth available for the management device at the managed device side according to current situation;
determining, by the managed device, a link bandwidth between the management device and the managed device according to one of the VPI and VCI at the management device side and the bandwidth at the managed device side; and
notifying, by the managed device, the management device through a response message.

15. The method of claim 14, wherein the current situation comprises at least one of an installation phase, a configuration phase, and a normal operation phase.

16. The method of claims 1, wherein the management device is an element management system (EMS) and network management system (NMS), and the managed device is a network element (NE) and EMS; or the management device is an NMS, and the managed device is an EMS.

17. A system for automatically realizing a connection between a management device and a managed device, comprising:
an address service device adapted to provide connection configuration parameters of a managed device and a management device for the managed device to establish the connection between the management device and the managed device.

18. The system of claim 17, wherein the address service device comprises:
a Dynamic Host Configure Protocol (DHCP) server, adapted to assign an address for the managed device, and provide the address of the management device for the managed device.

19. The system of claim 17, wherein the address service device comprises:
a DHCP server, adapted to assign an address for the managed device, and provide an ID of the management device for the managed device; and
a naming server, adapted to provide the address of the management device for the managed device.

20. A system for automatically realizing a connection between a management device and a managed device, comprising
a management device; and
a managed device,
wherein the management device and the managed device pre-configure one of a constant virtual path identifier (VPI) and a virtual channel path (VCI), and establish an initial link using one of the VPI and the VCI, and wherein
the managed device is adapted to report one of a VPI and a VCI available for the managed device to the management device through the initial link; and
the management device is adapted to detect the one of the VPIs and VCIs available for the managed device, and negotiate with the managed device to acquire the negotiation bandwidth to determine the one of the VPI and VCI assigned for the link.
